(19) United States
(12) Patent Application Publication
(10) Pub. No.: US 2008/0163409 A1
(43) Pub. Date: Jul. 10, 2008

(54) Flying insect management for outdoor enthusiasts

(76) Inventor: Deborah Humiston, Exeter, NH (US)

Correspondence Address: THOMAS P. GRODT ATTORNEY AT LAW, 4 PEABOY ROAD ANNEX, DERRY, NH, 03038, US

(21) Appl. No.: 11/651,356

(22) Filed: Jan. 9, 2007

(51) Int. Cl. A42B 3/04; A01M 1/14

(52) U.S. Cl. 2/410; 43/114

(57) ABSTRACT

The present invention is directed toward an apparatus for controlling flying insects about the head of a person and includes a head covering sized and dimensioned to fit upon the head of the person being bothered by flying insects. A card having a bottom surface, a top surface, and an insect trapping surface is removably attached to the head covering and oriented such that the bottom surface is next to the head covering and the top surface that includes the insect trapping surface is facing outward away from the head cover. The insect trapping surface includes an adhesive coating that is sufficiently sticky to adhere insects and moreover, includes a removable covering that protects the adhesive layer prior to use. The present invention also includes at least one covering flap for covering the adhesive coating after use to cover said adhesive surface and any trapped insects on said insect trapping surface.

### BACKGROUND

Flying insects have bothered and annoyed outdoor enthusiasts since time immemorial. Typically, outdoor enthusiasts have used chemical insect repellants on their skin in an attempt to keep flying insects from landing on their skin and biting them. Chemical repellants may harm the environment and may harm the user as well. However, even when successful and when used in such a way as to minimize the impact on the user and the environment, chemical repellants do not prevent the flying insects from annoying the outdoor enthusiast by flying around their fact and chemical repellants do not reduce the number of flying insects in any way. What is needed therefore is a new apparatus and/or method for controlling the number of flying insects surrounding a user that is not harmful to the environment or the user.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention is directed toward an apparatus for controlling flying insects about the head of a person and includes a head covering sized and dimensioned to fit upon the head of the person being bothered by flying insects. A card having a bottom surface, a top surface, and an insect trapping surface is removably attached to the head covering and oriented such that the bottom surface is next to the head covering and the top surface that includes the insect trapping surface is facing outward away from the head cover. The insect trapping surface includes an adhesive coating that is sufficiently sticky to adhere insects and moreover, includes a removable covering that protects the adhesive layer prior to use. The present invention also includes at least one covering flap for covering the adhesive coating after use to cover said adhesive surface and any trapped insects on said insect trapping surface.

The head covering may be any sort or hat, cap, hood, or helmet and the card may be affixed to the head cover using pins, hook and loop fasteners, snaps, double sided tape, basting stitches or other attachment means.

Typically the card is attached to the head cover at or near the crown or highest portion of the head cover and two or more cards may be used about the head cover to provide greater capture surface area.

### BRIEF DESCRIPTION OF THE DRAWINGS

These and other features, aspects, and advantages of the present invention will become better understood with regard to the following description, appended claims, and accompanying drawings. The drawings are not necessarily to scale, emphasis instead being placed on illustration of principles of the invention. The drawings include the following figures

FIG. 1 is a perspective view of the present invention; and

FIG. 2 is a perspective view of the insect holding surface of the present invention.

### DETAILED DESCRIPTION OF THE DRAWINGS

The present invention may be understood by the following detailed description, which should be read in conjunction with the attached drawings. The following detailed description of certain embodiments is by way of example only and is not meant to limit the scope of the present invention.

The present invention is directed toward an apparatus and method that takes advantage of a behavior of at least some flying insects to land on the highest point on a person. The user who is wearing a head cover of some sort affixes a piece of material having an adhesive material on a surface to the head covering such that the material is at or near the a portion of the highest point of the head covering. Flying insects will land on or near the highest point of the head covering and become stuck in the adhesive material.

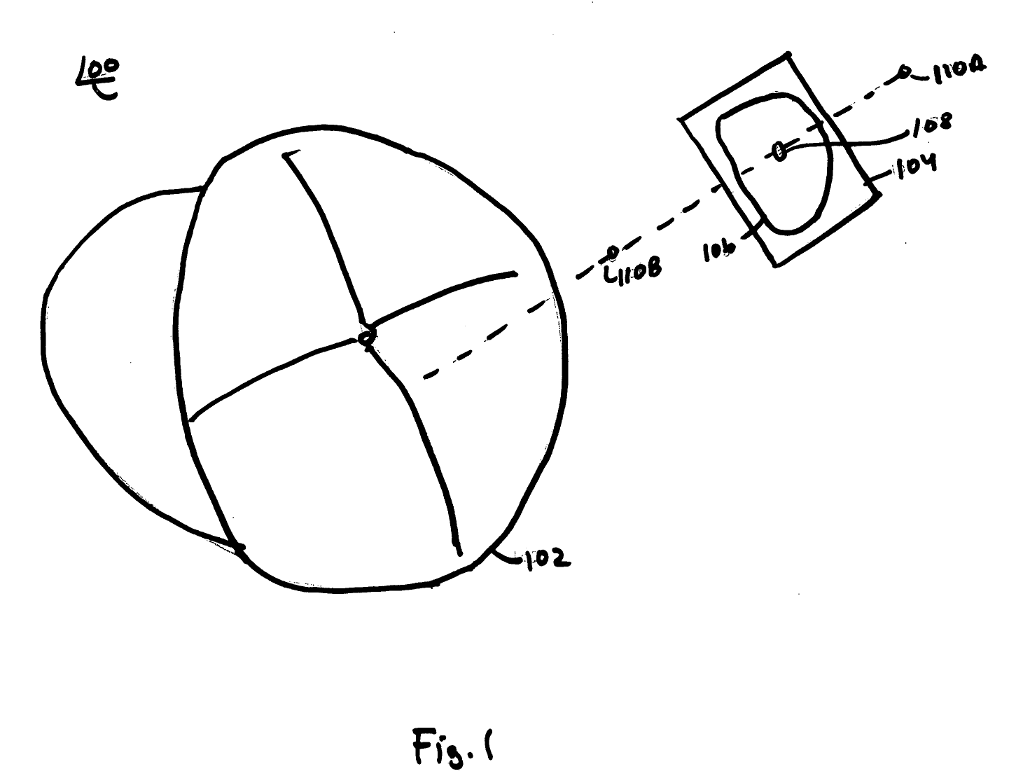

As depicted in FIG. 1 the present invention includes a head cover 102. The head covering may be hat, defined herein as a shaped covering for the head, typically with a brim and a crown, a stocking cap defined herein as a close fitting cone shaped knitted cap, a cap being defined as a soft flat hat with a peak, often with a brim or visor like portion, a bike or mountain climbing helmet, or a hood attached to a coat, jacket, or sweatshirt. The present invention further includes a card 104 or other material that includes an insect trapping surface. The insect trapping surface is an adhesive layer 106 that covers at least a portion of the top surface of the card 104. The adhesive layer 106 may be fly tape adhesive or other adhesive material that is sufficiently sticky to keep a flying insect from escaping once the flying insect has landed on the adhesive surface 106. In addition, the adhesive material 106 is selected such that it will not harden over a typical period of use, for example over a period of days or weeks, and furthermore will not lose its adhesive characteristics over this period as well. In addition, the adhesive should be able to withstand some moisture without losing its adhesive nature. In other environments, the adhesive should be waterproof. In still other environments, the adhesive should be able to withstand sustained exposure to the sun and in still other environments the adhesive should be able to withstand dry environments without losing its adhesive quality.

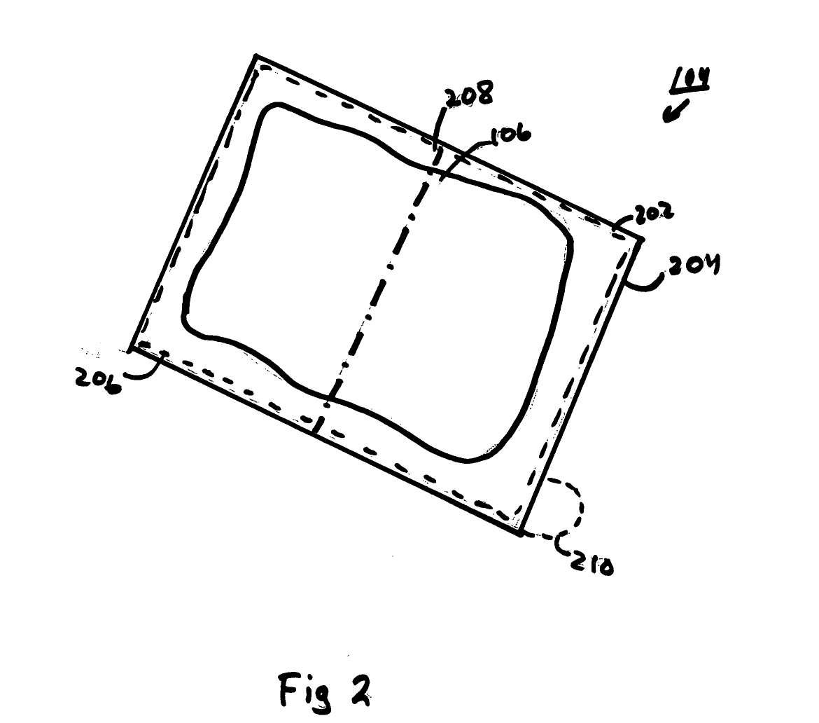

The card 104 may any suitable material that can support the adhesive layer 106 to form the insect trapping surface. As depicted in FIG. 2, the card 104 includes an upper surface 202, on which the insect trapping surface 106 is disposed upon and a bottom surface 204 that is placed adjacent to the head cover when in use. For example, the card may be cardboard, pressed paper, Mylar, plastic; or nearly any other material may be sued that can be formed into a desired shape, be covered with an adhesive surface, and attached to the head cover. In some environments, for example in humid or rainy environments, the material should be able to withstand at least some moisture without substantially deforming or losing the ability to support the insect trapping surface. In other environments, the card 104 should be waterproof to some extent. In still other environments, the adhesive should be able to withstand sustained exposure to the sun and in still other environments, the adhesive should be able to withstand dry environments without losing its ability to support the insect trapping surface. As an example, an adhesive that is suitable for use in a cooler and less humid New England may not be suitable for use in the South due to the increased temperature and humidity.

The material may be removably attached to the hat using any suitable attachment method. A pin 110A and a pin receiver 110B may be used in a simple and known manner and the pin 110A may be a safety pin as well and in this instance a pin receiver 110B is in general not needed. In addition, the card 104 may be removably affixed to the hat 102 using hook and loop fasteners such as Velcro®, a male and female snap mechanism, double sided tape, a button may be affixed to the head cover 102 and a corresponding button hole may be made in the card 104, or the button hole may be made in the head cover 102 and the button attached to the card 104. In addition, the card may be attached using basting stiches, i.e., long loose stiches that are easily sewn and easily removed. In another embodiment, magnets may be used, wherein one or magnets are affixed to the bottom surface 204 of the card and one or more magnets are placed on the inside of the head cover to hold the card by the magnet attraction of the two or more magnets. In general, the magnets must be sufficiently strong to hold the card in place the presence of wind or air drafts caused by cycling or running.

In another embodiment, more than one piece of material having an adhesive surface may be used at various locations on the hat to provide greater coverage of the surface area of the hat.

In general, the adhesive should be protected prior to use. Therefore, a removable flap 206 covering the adhesive prior to use is provided to protect the adhesive layer 106. When the adhesive has either lost its adhesive ability or the adhesive surface is filled with trapped flying insects, one or more flaps (not shown) may be provided that fold over the top surface of the card 104 covering the adhesive layer 106 and any insects trapped thereon. The one or more flaps may be disposed on and lightly adhered to the bottom surface 204 of the card 106 and configured to be easily removed by the user. In addition, the flap 206 may be folded under the card 104 and lightly adhered or otherwise affixed to the bottom surface 204 and reused to form the protective flap. This prevents a user from having to touch the adhesive surface or the trapped flying insects when removing and/or replacing the card 104. Other methods may be used to allow the user to remove the material without having to touch the material's adhesive surface or the flying insects trapped thereon. For example, the card may have scored lines 208 that allow the card to be folded by the user so that the user only touches the bottom surface 204 of the card 104. In another embodiment, a handle portion 210 projecting out form the periphery of the card 104 and sized such that the user may grasp it using their thumb and forefinger may be situated such that the user may remove the card 104 by touching only the handle portion.

In another embodiment, a holder (not shown), typically made of plastic although other lightweight materials may be used, may be used to hold the card in place. In this embodiment, the holder may be affixed to the head cover using the methods described above. In addition, the holder may be sized and configured to hold more than one card so that when one card is removed, the next card is available within the holder. The cards may be secured together on a single edge and torn off when used or placed individually within the holder and simply removed.

In addition, scents, colors, a combination of scents and colors, or other types of lures for flying insects may be added to the material or to the adhesive surface to attract flying insects to the adhesive surface and to trap them there.

While the present invention has been particularly shown and described with references to preferred embodiments thereof, it will be understood by those skilled in the art that various changes in form and details may be made therein without departing from the spirit and scope of the invention as defined by the appended claims. All the features disclosed in this specification, including any accompanying claims, abstract, and drawings, may be replaced by alternative features serving the same, equivalent or similar purpose, unless expressly stated otherwise.

What is claimed is:

1. An apparatus for controlling flying insects about the head of a person, ths apparatus comprising:
a head covering sized and dimensioned to fit upon the head of the person;
a card including an insect trapping surface having an adhesive coating, said card having an bottom surface and a top surface, said insect trapping surface being removeably affixed to said head covering wherein said bottom surface is proximal to said head covering and said outer surface is distal to said head covering;
said adhesive coating covering a portion of said top surface and being sufficiently sticky to adhere insects to said insect trapping surface, wherein said insects are trapped on said insect trapping surface;
said insect trapping surface including a removable covering, said removable covering at least the adhesive coating and being removable therefrom;
said insect trapping surface including at least one covering flap for covering at least said adhesive coating, wherein said covering flap is used to cover said adhesive surface and any trapped insects on said insect trapping surface.

2. The apparatus of claim 1, wherein said head covering is one of the following group a hat, a cap, hood, bike helmet, or mountain climbing helmet.

3. The apparatus of claim 1 wherein said insect trapping surface is affixed to said head covering via hook and loop fasteners affixed to said head covering and said bottom surface.

4. The apparatus of claim 1 wherein the insect trapping surface is affixed to said head covering via a two piece snap mechanism, wherein a male snap member and a corresponding female snap member are affixed on the head covering and the bottom surface.

5. The apparatus of claim 1 wherein the insect trapping surface is affixed to said head covering via a button and corresponding button hole, wherein the button hole is sized and dimensioned to accept and hold said button are placed on corresponding locations of said head covering and said bottom surface.

6. The apparatus of claim 1 wherein the insect trapping surface is affixed to said head covering using a pin.

7. The apparatus of claim 6 wherein the pin is a straight pin and a pin receiver.

8. The apparatus of claim 6 wherein the pin is a safety pin

9. The apparatus of claim 1 wherein the insect trapping surface is affixed to said head covering via double sided tape placed between the head covering and the bottom surface.

10. The apparatus of claim 1 wherein the insect trapping surface is affixed to said head covering at a high point on said head covering.

11. The apparatus of claim 1 wherein the insect trapping surface is affixed to said head covering near the high point of the head covering.

12. The apparatus of claim 1 wherein the insect trapping surface is affixed to said head covering near the high point of the head covering and on the rearward surface of the head covering.

13. The apparatus of claim 1 wherein the insect trapping surface includes a plurality of insect trapping surfaces each removeably affixed to the head covering and differently oriented about said head covering.

14. The apparatus of claim 1 wherein the card further includes scored portions to allow said card to be bent along said scored portions.

15. The apparatus of claim 1 wherein said card further includes a gripping portion projecting outward from the card, said gripping portion sized and dimensioned to be grasped by a thumb and forefinger of the user.

16. The apparatus of claim 1 wherein said adhesive coating further includes lures to attract flying insects.

17. The apparatus of claim 1 wherein said removable covering is reusable as said covering flap.

18. The apparatus of claim 1 wherein said covering flap is disposed on said bottom surface of said card and is detachable from said bottom surface and sized and configured to allow said covering flap to cover said insect trapping surface.

19. An apparatus for controlling flying insects about the head of a person, ths apparatus comprising:
a head covering sized and dimensioned to fit upon the head of the person;
a card including an insect trapping surface including an adhesive surface,
said adhesive coating covering a portion of said top surface and being sufficiently sticky to adhere insects to said insect trapping surface, wherein said insects are trapped on said insect trapping surface;
said insect trapping surface including a removable covering, said removable covering at least the adhesive coating and being removable therefrom;
said insect trapping surface including at least one covering flap for covering at least said adhesive coating, wherein said covering flap is used to cover said adhesive surface and any trapped insects on said insect trapping surface; and a plastic holder sized and configured to hold at least one card said holder having a bottom surface and a top surface, said holder being removably affixed to said head covering wherein said bottom surface of said holder is proximal to said head covering and said outer surface of said card with said insect trapping surface is distal to said head covering.

20. The apparatus of claim 19 wherein the at least one card includes a plurality of cards held within the holder.

21. The apparatus of claim 20 wherein the plurality of cards are secured together within said holder.

22. The apparatus of claim 20 wherein the plurality of cards are individually placed within said holder.
